(19) United States
(12) Patent Application Publication
(10) Pub. No.: US 2016/0337704 A1
(43) Pub. Date: Nov. 17, 2016

(54) SYSTEM AND METHOD FOR CONTENT DELIVERY BY SUBSCRIBER PERSONAL CHANNEL

(71) Applicant: LAYER3 TV, INC., Denver, CO (US)

(72) Inventors: Jeffrey BINDER, Denver, CO (US); Charles A. Hasek, IV, Denver, CO (US)

(73) Assignee: LAYER3TV, INC., Denve, CO (US)

(21) Appl. No.: 14/710,588

(22) Filed: May 13, 2015

(51) Int. Cl. H04N 21/482; H04N 21/2668; H04N 21/431; H04N 21/433; H04N 21/45; H04N 21/25

(52) U.S. Cl. CPC H04N 21/4826; H04N 21/4532; H04N 21/251; H04N 21/4312; H04N 21/4332; H04N 21/2668

(57) ABSTRACT

The present invention relates to an improved system and method for providing a personal channel of linear programming to a subscriber in a content delivery network (CDN). The system and method of creates a linear channel for a subscriber in a predetermined arrangement of program scheduling from file information corresponding to media content data in predetermined arrangement of program scheduling to optimize the playback and the user experience. The predetermined arrangement of program scheduling is determined from one or more user characteristics based on service requests from the user or subscriber's interaction with a resource manager, a scheduler service and/or catalog service. According to methods of the present invention the personal channel for channel creation may be based on content provider, who will structure channels for a particular area, subscriber or other grouping of any available program scheduling. The personal channel of linear programming may be configured to use media content that has been predetermined for a particular personalized channel, whereby such a personalized channel may also change content from program to program, so that a version of the channel would be similar but unique to the viewer, such that a linear channel may be the basis service but individual programs will be swapped out from file information for the desired media content e.g. VOD, DVR, NDVR or other file based sources from said CDN.

### FIELD OF THE INVENTION

The present invention relates to video programming network and, more particularly, to an improved system and method for providing a personal channel of linear programming to a subscriber in a content delivery network (CDN).

### BACKGROUND OF THE INVENTION

In conventional broadcasting, the broadcast network determines particular programming of content for geographic markets and time slots based on a number of factors such as, for example, for the afternoon time slot (e.g. 1 PM-3 PM) the supply of soap opera programming is geared toward a drama oriented homemaker, which reflects the appeal of this program category in this time slot. In this sense advertisers and programmers have invested millions of dollars in attempts to reach audience segments of a particular age, sex or income level. As a result, various program categories have been established that are then utilized to populate the channel with particular programming content for geographic markets and time slots.

Presently, programming aggregated by over-the-air TV, cable systems, digital broadcast satellite (DBS) and other content delivery network (CDN) sources run channel lineups determined by the broadcast network linear programming A subscriber and/or user over-the-air TV, cable TV, digital broadcast satellite (DBS) TV and other TV sources is presented with viewing options of essentially what's “on” right now in the CDN. In order to achieve variety, the subscriber changes channels to select a particular channel for viewing, i.e. channel surfing. As a result, present conventional broadcasting and CDN's are limited to linear programming of this type.

Conventional network systems and methods have these limitations and disadvantages in providing non-linear programming to the user, whereby the subscriber has no means of creating a personal channel for the user's particular desired content consumption

As a result, there is a present need to provide a content delivery network (CDN) system and method of making a linear channel for a subscriber to optimize the playback and the user experience.

### SUMMARY OF THE INVENTION

It is an object of the present invention to provide system and method of making a linear channel for a subscriber to optimize the playback and the user experience.

It is an object the apparatus, system and method of the present invention to overcome the disadvantages of the prior art and add flexibility in creating and recording linear and non-linear content with respect a personal channel of a subscriber and user.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Description of the Embodiments, which is to be read in association with the accompanying drawings, which are incorporated in and constitute a part of this specification, show certain aspects of the subject matter disclosed herein and, together with the description, help explain some of the principles associated with the disclosed implementations, wherein:

FIG. 1 is a schematic diagram illustrating system and method of content delivery and recording of linear and non-linear media content in accordance with an embodiment of the present invention;

FIG. 2 is a schematic diagram illustrating the digital video recording system and method of recording linear and non-linear media content in an adaptive bit rate (ABR) Content Delivery Network (CDN) device in accordance with an embodiment of the present invention;

FIG. 3 is a schematic diagram illustrating the conventional linear and non-linear media content delivery;

FIG. 4 is a schematic diagram illustrating subscriber personal channel linear and non-linear media content delivery in accordance with an embodiment of the present invention; and

FIG. 5 is a flowchart illustrating the method of recording linear and non-linear media content in accordance with an embodiment of the present invention.

### DESCRIPTION OF THE EMBODIMENTS

Non-limiting embodiments of the present invention will be described below with reference to the accompanying drawings, wherein like reference numerals represent like elements throughout. While the invention has been described in detail with respect to the preferred embodiments thereof, it will be appreciated that upon reading and understanding of the foregoing, certain variations to the preferred embodiments will become apparent, which variations are nonetheless within the spirit and scope of the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “some embodiments”, “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are provided for the purposes of illustrating some embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “DVR” refers to a device or application software that digitally compressing analog and/or video feeds and storing these feeds in memory (i. e. that records video in a digital format to a hard-drive, system memory, a disk drive, USB flash drive, SD memory card, SSD or other local or networked mass storage device, etc.). The term includes set-top boxes (STB) with direct to disk recording facility, portable media players (PMP) with recording, recorders (PMR) as camcorders that record onto Secure Digital memory cards and software for personal computers which enables video capture and playback to and from a hard disk drive. The term “digital” referring to the compression and storage technology, not the transmitted video images.

As used herein the term “network digital video recording” or “nDVR” refers to a device or application software that stores digital images or video on the network “in the cloud” (e.g. directly from the IP-network into a networked mass storage device). As used herein the term “Quality of Services” or “QoS” refers to a device or application software device is one that is capable, in order to comply with bandwidth limitations of a network, of limiting the transmission rate it uses for transmission or reception over the network. A QoS device may be capable of negotiating with a system resource manager for varying amounts of bandwidth.

As used herein the term “application programming interface” or “API” refers to a software component in terms of its operations, inputs, outputs, and underlying types is a set of routines, protocols, and tools for building software applications.

The invention is a personal channel system and method for recording digital content to ensure quality of the user experience is generally designated as numeral 100. According to an embodiment, the personal channel system and method 100 may be formed and implemented using a digital video recorder (DVR) integrated a devices (e.g. a set-top box) and/or on a network digital video recorder (nDVR). The system and method 100 provides a user the ability to backing up and playing recorded program material linear and non-linear content media (e.g. TV broadcast programs, VOD, and digital video). The system and method 100 may be implemented in a content delivery network (CDN) system using computers to distribute copies of data placed at various nodes of a network by subscription to the device of a user by pulling ABR segments from storage available on the CDN. According to one embodiment, the content media may be, for example, linear broadcasting and non-linear or VOD content media (e.g. audio and podcast hosting, video delivery, live streaming, flash streaming), downloadable objects (media files, software, documents), live broadcast linear and database queries. Numerous devices are available for a user to play the content media such as TV, HD-monitors, mobile devices

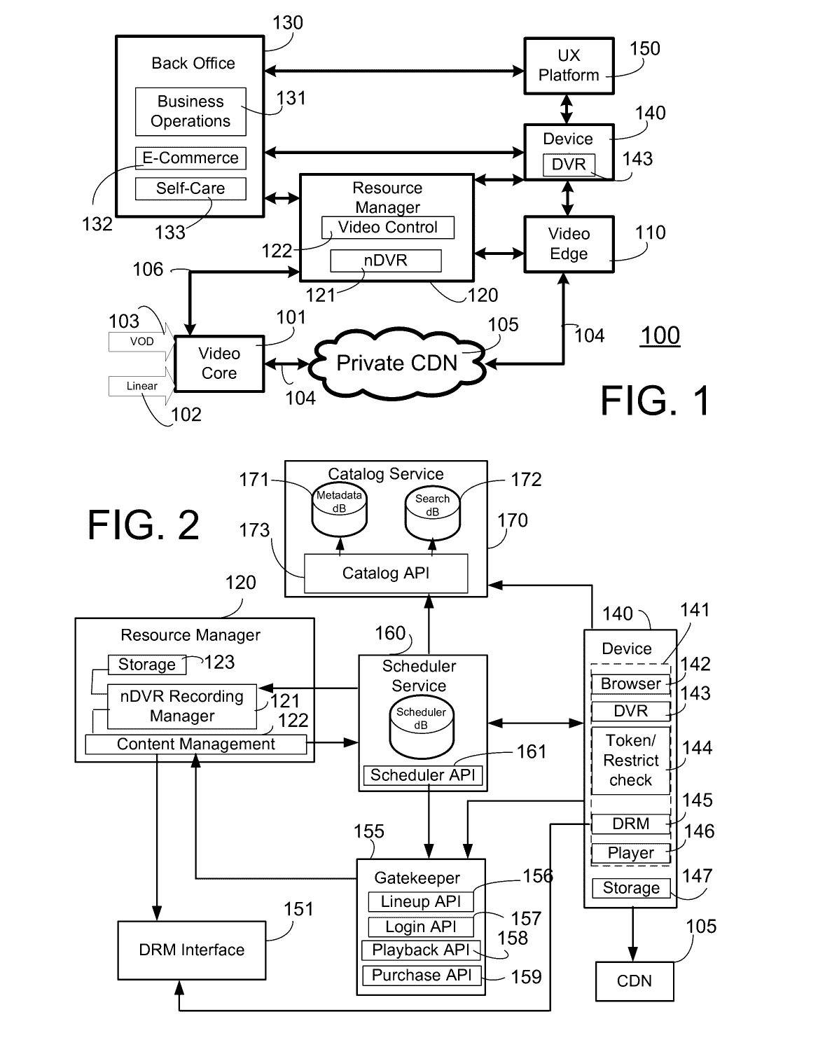

Referring to FIGS. 1 and 2, a personal channel system and method 100 generally comprises a video core 101 is adapted for content processing and communication for ingesting and packaging linear 102 (e.g. live broadcasting) and non-linear 103 (e.g. video on demand (VOD)) and linear content 103 by communication lines 104 across a communication network 105 to the video edge 110 to service a device 140 (e.g. set-top box, tablet, smart phone, computer, etc.) of a user that subscribes to content subscription service. The video core 101 in the content processing and communication system also communicates with a resource manager 120 over communication lines 106 to provide information about the ingested and packaged linear 102 and non-linear 103 such as, for example, by maintaining a manifest file. The system 100 also comprising a back office 130 with business operations 131 (e.g. regulations, licenses, etc.), e-commerce 132 (e.g. subscriber billing, payments, etc.) and a self-care 133 portal (e.g. updates, remote servicing of devices, etc.). The user experience platform 150 may be a multi-dimensional platform to present content media to the user in a predetermined graphical user interface (GUI). A digital rights management (DRM) interface 151 is adapted to interface with the user device 140.

The resource manager 120 is responsible for allocating, monitoring, and controlling resources, particularly pulling ABR segments and bandwidth therefor, for recording and playback related services. The resource manager 120 operates in the delayed DVR system and method 100 to authorize viewing of copyrighted content according to policies and rights management across the CDN 105.

According to an embodiment, personal channel system and method 100 can be configured to use ABR technologies to transmit the content media files over HTTP for distribution across the CDN 105. In this manner, personal channel system and method 100 uses the advantages of ABR by dynamically monitoring CPU and memory capacity to make corresponding adjustments in the video quality of the transmitted content media by encoding the source linear and non-linear content (e.g. live broadcast, movie, video, etc.) at varying bit rates, and then segmenting each of the different bit rate streams. The segment length may be a predetermined size and duration, for example, between 2 and 10 seconds. The client or user's device 130 includes a player 146 to use the ABR advantageously to switch among the different bit rate segments, thereby locating the segments that correspond best to the bandwidth.

Referring to FIGS. 1 and 2, the resource manager 120 is responsible for allocating, monitoring, and controlling resources, particularly pulling ABR segments and bandwidth therefor, for recording and playback related services. The resource manager 120 may integrate a network DVR (nDVR) 121 for the recording and/or playback of linear 102 and non-linear content 103 by video control 122. According to a DVR embodiment, the device 140 may integrate a DVR recorder 143 for the recording and/or playback of linear 102 and non-linear content 103 in storage on the device. It is to be appreciated that the ABR segment may be pulled from storage in CDN 105 may provide the nDVR 121 resource in the cloud and DVR 143 on the device 120 for the user.

A CDN system may be configured as described in U.S. patent application Ser. No. 14/765,575 entitled System and Method of Distributing Content Based On Trending and Preemptive Data, which is incorporated by reference in its entirety. A preferred embodiment of the invention when recording TV, video and/or movie content media files, the video core 101 ingests non-linear 102 and linear content 103 and packages to encode in, for example, adaptive bit rate (ABR) segments or in one or more multiple bit rate segments and file information (e.g. MPEG formatted segments extracted from the analog and digital TV signal streams, for and storage example, analog forms such as National Television Standards Committee (NTSC) or PAL broadcast, and digital forms such as Digital Satellite System (DSS), Digital Broadcast Services (DBS), or Advanced Television Standards Committee (ATSC). According to an embodiment, the ABR segment pulling DVR system and method 100 may be configured to transfer content media files (e.g. media segments representing frames of video or other programming) by way of Transmission Control Protocol (TCP)/Internet protocol suite (IP). TCP/IP transfer may use a variety of protocols (e.g. HTTP, HTTPS, SMTP, POP3, IMAP, SSH, FTP, Telnet, etc.) encapsulated in TCP to transfer and deliver across the CDN 105 network 105 from the video core 104 to the video edge 110 closest to the client device 140. system and method 100 can be configured to use ABR technologies to transmit the content media files over HTTP for distribution across the private CDN 105. In this manner, ABR segment pulling DVR system and method 100 uses the advantages of ABR by dynamically monitoring CPU and memory capacity to make corresponding adjustments in the video quality of the transmitted content media by encoding the source linear and non-linear content (e.g. live broadcast, movie, video, etc.) at varying bit rates, and then segmenting each of the different bit rate segments. The media segment length may be a predetermined size and duration, for example, between 2 and 10 seconds. The client or user's device 130 includes a player 146 (as shown in FIGS. 1 and 2) to use the ABR advantageously to switch among the different bit rate segments, thereby locating the segments that correspond best to the bandwidth.

According to an embodiment of the invention, the video core 101 is configured to ingest, segment and package the input linear 102 and non-linear 103 media content into ABR segments for later pulling ABR segments across CDN 105 to the video edge 110 for accessing by the user's device 140. A catalog of file information, metadata and other information about the content 102, 103 is written into a manifest file that is stored on a resource manager 120 for video control 122. When the user accesses the content media file(s) 102, 103, the user's device 140 requests the segments from the CDN by an address given in the manifest file. The resource manager 120 controls pulling of ABR segments of content media file(s) 102, 103 the user's device for playback and display. The player 146 in the device 140 may be configured to play the linear and non-linear content media file(s) 102, 103 to create an optimum user experience.

In an exemplary embodiment, as is illustrated in FIGS. 1-2, a user has a device 140 which has may have application software 141 loaded in memory of the device 140, e.g. a set-top box or satellite DVR receiver. In establishing a recording, the device 140 checks with the gatekeeper module 188 to determine the users privileges, the user's metadata, the lineup data, performs a restrictions check such as passing an authorization token, and also may be used to purchase media content. The application software 141 may be configured as application programming interfaces (API). The application software 141 may be configured with a browser 142, a digital video recorder (DVR) 143, authorization token or restriction checker 144, a digital rights management (DRM) module 145, and content media player 146. The application software 141 is adapted to login to a gatekeeper 155 module of the resource manager 120. The gatekeeper 155 also utilizes APIs for various the subscriber data services for policies of acquisition, persistence, and consumption for the media content that may be established by the back office 130. The gatekeeper 155 can be used in recording linear 102 and non-linear 103 media content including a lineup API 156, login API 157, playback API 158 and purchase API 159. The digital recording functionality may be configured to pull ABR segments by assembling media segments to create a temporal viewing experience (such as time shifting) by reassembling the segments into the original order of the content program being viewed at an alternate time from the original airdate of the program. Any pulled media segments are delivered to the device 140 by resource manager 120 by requests of the device 140 making an active request to retrieve those segments from the network (for instance, using a Content Delivery Network).

The media segments are not multicast or broadcast to the end client, but can only be retrieved by an active request to pull them (for instance, using HTTP GET request) from the network serving device, such as a CDN. The mechanisms may make use of technologies such as adaptive bit-rate (ABR), fragmented MPEG-4 files or other formats that can typically delivered via download technology such as HTTP. Media segments could be delivered in real-time, near real-time or delivery (to account for network blocks, conservation of network resources or other use-cases). Media Segments would typically be video encapsulated in a format used to traverse the network and then made available for playback via a media player, though the segments could encompass other media types such as just audio, images, web hyperlinks, etc. Media Segments would typically consist of a program based on a time boundary, the program may be interspersed with other Media Segments such as for an advertisement, blackout/alternate content or other customized programming within the program boundary.

Referring to FIG. 2, the scheduler service 160 is utilized by the system when the user scheduling that may be comprised as a scheduler API 161 and a schedule dB. The scheduler service 160 is utilized to operate in connection with a resource manager to create program schedule information, whereby said scheduler is configured to provide a catalog of media content data to display to the user said program schedule information at a predetermined time by the user communicating a selection to said resource manager. The scheduler service 160 can be configured to communicate with the resource manager 120, the device 140 of the user, a gatekeeper 155 for effectuating policies associated with the user and/or user's subscription, and a catalog service 170. The user utilizes the scheduler service 160 to specific channels to view from the guide or line-up displayed, user privileges, and other settings (e.g. such as DVR settings and preferences default DVR scheduling settings. The scheduler service 160 checks with the gatekeeper 155 for authentication, entitlement check, and other account data for the particular user. The catalog service 170 for providing meta data information about the media content that is stored in a metadata database 171 and with search capabilities using a search database 172. The catalog service 170 may be implemented in a software program or catalog API 173. Scheduling of the recording of the media segments may occur either in the local host or the cloud/server side program scheduler. The digital recording functionality of pulling ABR segments may be utilized advantageously to reduce system overhead in the delivery to the device of the subscriber or user. Moreover, such resources that may be utilized for other functions such as, for example, forming multiple ABR segments of the highest higher resolution on the ingestion of high bit rate video

According to an embodiment, the personal channel system and method 100 may be configured to transfer content media files (e.g. frames of video) by way of Transmission Control Protocol (TCP)/Internet protocol suite (IP). TCP/IP transfer may use a variety of protocols (e.g. HTTP, HTTPS, SMTP, POP3, IMAP, SSH, FTP, Telnet, etc.) encapsulated in TCP to transfer and deliver across the CDN network 105 from the video core 101 to the video edge 110 closest to the client device 140. In a movie, video or broadcast, frames and/or file information of the content media data are stored in a manifest file. Frames and/or file information of the content media data occur in a predetermined order based on time.

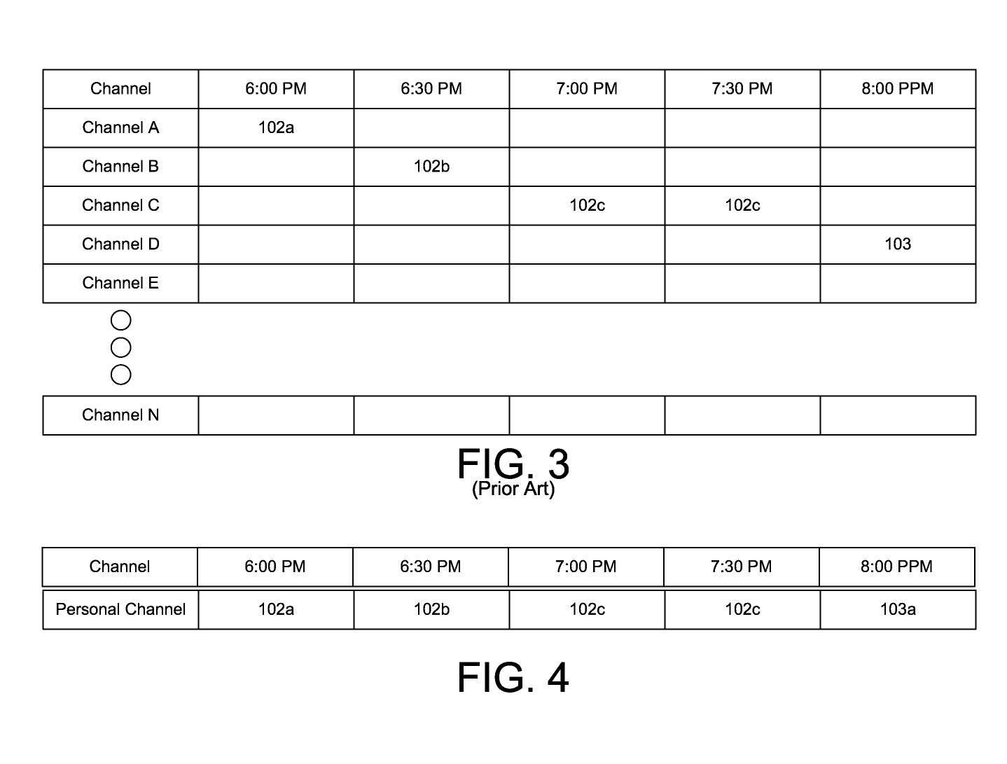

Referring to FIG. 3, conventional systems and methods for distributing programming by over-the-air TV, cable systems, digital broadcast satellite (DBS) and other CDN source provide a guide of aggregated media content available. The guide is a list of channels in a general table or line-up determined by the broadcast network linear programming and published several days before airing, for example, by guide data provided by Tribune Media Services (TMS). A subscriber using a set-top box cable systems, digital broadcast satellite (DBS) and other CDN source is presented with viewing options of essentially what's “ON” right now in the CDN.

In order to achieve variety, or change the displayed program of media content, the set-top box provides the guide to the subscriber who uses the guide to change channels to select a particular channel for viewing, i.e. commonly referred to channel surfing. For example, the subscriber may be presented with a programming schedule according to time slots for viewing and make user inputs as desired, for example, Channel A local news (6:00 PM to 6:30 PM), Channel B national news (6:30 PM to 7 PM), Channel C news commentary (7:00 PM to 8:00 PM), Channel D a movie or television series available from on-demand or DVR (VOD content 103) and the like. At the time 6:30 PM (i.e., termination of local news programming aired at 6:00 PM to 6:30 PM on Channel A) from the linear media content 102a, the subscriber is required to change to Channel B for national news program being aired between 6:30 PM to 7 PM to receive this linear media content 102b. Similar subscriber inputs are required to change from Channel B to Channel C for desired programming of news commentary (7:00 PM to 8:00 PM) linear media content 102c aired at the predetermined termination time of Channel B programming at 7 PM. Likewise, subscriber input(s) are required to change from Channel C to Channel D for desired programming of on-demand or VOD non-linear media content 103a.

Conventional systems require the subscriber to move essentially from one channel to the next. As a result, conventional network systems and methods have limitations and disadvantages in providing the user or subscriber with guides and line-ups of linear and non-linear programming, as the subscriber has no means of creating a personal channel for the user's particular desired content consumption. Moreover, conventional systems and methods lack capability to gather one or more user characteristics so as to “learn” over time from the user's viewing of linear and non-linear programming As a result, there is a present need to provide a content delivery network (CDN) system and method of making a linear subscriber personal channel based on one or more user characteristics gathered for a subscriber to optimize the playback and the user experience.

According to an embodiment of the present invention illustrated in FIG. 4, a linear subscriber personal channel based on one or more user characteristics gathered for a subscriber may be created to optimize the playback and the user experience. The one or more user characteristics are gathered for a subscriber over a predetermined time. The personal channel system and method 100 gathers the one or more user characteristics from the user or subscriber's inputs from selections from a guide or a list of available linear and non-linear content 102, 103. The personal channel system and method 100 can be configured to displayed guide metadata associated with the available linear and non-linear content 102, 103 by a description or title, available times, source of the programming, etc. Each of these user inputs are received by the device 140 which are received as a service request by the resource manager 120. The resource manager 120 is configured to identify media content data information about the desired media content 102, 103, and other the program schedule information from CDN resources, e.g. the manifest file, scheduler service 160, catalog service 170.

Referring to FIG. 4, once the resource manager 120 gathers the one or more user characteristics from numerous subscriber service requests over the predetermined period of time. The resource manager 120 may be configured to process the service request for metadata file information useful for the one or more user characteristics of a particular media content data. The file information is useful to identify locations corresponding to media content data in the CDN such as from a manifest file. The resource manager 120 can be configured to determine the one or more user characteristics from the service requests over a predetermined period of time and the file information regarding the particular media content 102, 103. The resource manager 120 may be formed to store these user characteristics store in network storage 123 in the CDN or storage 147 on the device 140, or both.

Once one or more user characteristics are gathered from inputs from the device based on user interaction, the system and method 100 is configured to create a personal channel. As is illustrated in FIG. 4, resource manager 120 may be used to create the personal channel. For example, the subscriber personal channel will display the linear content 102a of Channel A local news (6:00 PM to 6:30 PM), linear content 102b of Channel B national news (6:30 PM to 7 PM), linear content 102c of Channel C news commentary (7:00 PM to 8:00 PM), and the non-linear content 103a of another Channel D for example, recommending a movie or television series available from on-demand or DVR (VOD content 103) such as resuming an episode in the “Game of Thrones” TV-series. The resource manager 120 is adapted to provide program scheduling from the scheduler service 160 and the catalog 170 so as to provide and display guide data for the subscribers personal channel.

The resource manager 120 prepares delivery of the media content data by identifying media content data and file information from the manifest file, catalog service 170 and scheduler service 160 for the line-up of linear media content 102a, 102b, 102c and non-linear media content 103a. Further subscriber inputs are not required to change from Channel A to Channel B, from Channel B to Channel C, or from Channel C to Channel D at the at the predetermined termination time for the particular aired programming which is an improvement over the prior art. Similarly, the recommendation of the non-linear media content 103a available on Channel D is based on the one or more user characteristics from previous subscriber input(s) which is an improvement over the prior art.

According to an embodiment of invention, the personal channel system and method 100 may be configured to manage the transmission of desired media content over an access link between a device of a user and a source of the media content in a CDN according to the established personal channel. The CDN is configured for a content processing and communication system that is communicatively coupled with the resource manager 120. The content processing and communication system may be configured to identify the media content data (e.g. 102a, 102b, 102c and 103a) from a manifest file according to the subscriber personal channel formed by the resource manager 102. Again, the subscriber personal channel is formed in a predetermined arrangement of program scheduling as shown in FIG. 4. The predetermined arrangement of program scheduling is formed by the resource manager 120 from the one or more user characteristics from user interaction with the resource manager 120 over time. The one or more user characteristics are identified and gathered over time from sources in the CDN, for example, the resource manager 120, a scheduler service 160 and/or catalog service 170. Moreover, file information corresponding to media content data 102,103 aggregated in the predetermined arrangement of program scheduling (e.g. 102a, 102b, 102c, 103a, . . . ). The resource manager 120 uses the scheduler service 160 to scheduling and form guide data or line-up of the predetermined arrangement of program scheduling for displaying to the user. The resource manager 120 may be configured to determine the predetermined arrangement of program scheduling ahead of the time aired. The predetermined arrangement of program scheduling may be store in storage 123, 147 for use around the time of airing of programming for the subscriber's personal channel. Similarly, the resource manager 120 may be configured to obtain the media content data in the predetermined arrangement of program scheduling (e.g. 102a, 102b, 102c, 103a, . . . ) using the resource manager from sources in the CDN. The resource manager 120 may be configured to stream said media content data to the device 140 of the user associated the predetermined arrangement of program scheduling.

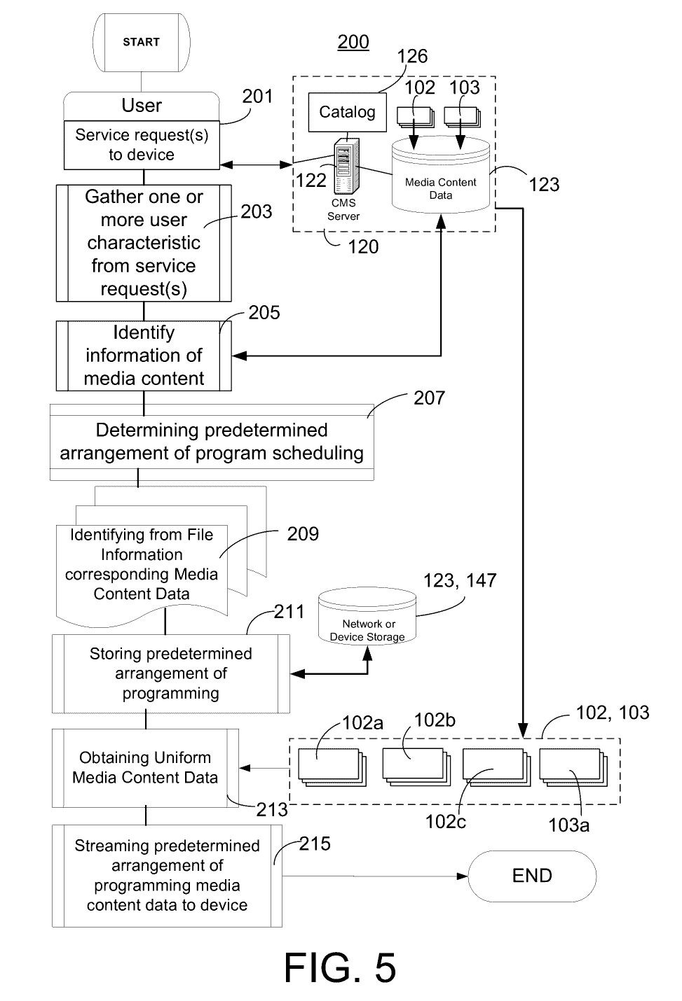

Referring to FIG. 5, in operation, the personal channel system and method 100 can be configured in a subscriber personal channel process 200 using the resource manager 120 and aspects of the CDN and system. The subscriber personal channel process 200 may be implemented by computer-implemented software or one or more APIs. Accordingly, the subscriber personal channel process 200 of the present invention described in creating a linear channel of linear and/or non-linear media content 102, e.g. live broadcasts, DVR, and/or VOD content. The CDN of the present invention can segment the live broadcast stream in to multi-bit rate streams of numerous resolutions, store the streams on the system and have file information of the media content 102 available to the resource manager such as, for example, a manifest file, catalog and scheduler file. As described herein, the subscriber personal channel process 200 overcomes these problems of the current system to create linear channel for an optimum user playback experience.

In a Step 201, one or more service requests input to the device 140 for desired media content 102, 103 are received by the resource manager 120 via the scheduler service 160. The scheduler service 160 may operate in connection with the resource manager 120 to request information of a catalog service 170, or the user's device 140 may seek information from the catalog service 170 directly, to provide a catalog of media content data to display to the user, which is essentially a listing of linear and non-linear content 102, 103 available on the CDN to the subscriber after being ingested and packaged by video core 101. The list of available linear and non-linear content 102, 103 may be displayed using metadata associated with the content by a description or title, available times, source of the programming, etc. For example, the subscriber may be presented with a programming schedule according to time slots for viewing and make user inputs as desired, for example, Channel A local news (6:00 PM to 6:30 PM), Channel B national news (6:30 PM to 7 PM), Channel C news commentary (7:00 PM to 8:00 PM), Channel D a movie or television series available from on-demand or DVR (VOD content 103) and the like. Each of these user inputs are received from the device 140 by the resource manager 120 and processed for the program schedule information. The resource manager 120 is configured to determine one or more user characteristics from the service requests over a period of time.

In a Step 203, the resource manager 120 gathers the one or more user characteristics from repeated service requests supplied from the device 140. In a Step 205, the resource manager 120 is configured to identify media content data information about the media content 102, 103 from the manifest file in storage 123, 147.

In a Step 207, the resource manager 120 may be configured to determine a predetermined arrangement of program scheduling from the one or more user characteristics to create a personal channel. The predetermined arrangement of program scheduling may be based on the user's daily viewing of media content. For example, the subscriber may be presented with a personalized channel for viewing based on the one or more user characteristics, for example, Channel A local news (6:00 PM to 6:30 PM), Channel B national news (6:30 PM to 7 PM), Channel C news commentary (7:00 PM to 8:00 PM), Channel D a movie or television series available from on-demand or DVR (VOD content 103) and the like. The resource manager 120 is configured to identify media content data information about the media content 102, 103 from the manifest file in storage 123, 147.

In a Step 209, the resource manager 120 identifies the media content data 102, 103 required for the user's personal channel based on the predetermined arrangement of program scheduling from the one or more user characteristics.

In a Step 211, the resource manager 120 stores the user's personal channel, i.e. predetermined arrangement of program scheduling from the one or more user characteristics.

In a Step 213, the resource manager 120 starts the user's personal channel, i.e. predetermined arrangement of program scheduling by obtaining the media content data 102, 103. For example, media content data for a linear Channel A local news (6:00 PM to 6:30 PM), shown in FIG. 3 as element 102a, is obtained from storage 123, 147 by resource manager 120. Also, for example, media content data for a linear Channel B national news (6:30 PM to 7 PM), shown in FIG. 3 as element 102b, is obtained from storage 123, 147 by resource manager 120. Also, for example, media content data for a linear Channel C news commentary (7:00 PM to 8:00 PM), shown in FIG. 3 as element 102c, is obtained from storage 123, 147 by resource manager 120. Also, for example, media content data for linear Channel D (i.e. a movie or television series available from on-demand or DVR (VOD content 103)), shown in FIG. 3 as element 103a, is obtained from storage 123, 147 by resource manager 120.

In a Step 215, the resource manager 120 starts pulling ABR segments for the user's personal channel. The resource manager 120 is configured to pull and supply ABR segments of desiredmedia content data 102, 103 according to the predetermined arrangement of program scheduling such as, for example, media content data 102a, 102b, 102c, and 103. In this manner, the subscriber can create a personal channel and view linear programming 102a, 102b and 102c and non-linear programming 103c as shown in FIGS. 3, 4 and 5.

The user may choose be currently watching a live stream of linear content 102. The user may use the catalog service 170 to search for live events present or in the future to watch and/or record. The scheduler 160 communicates with the resource manager 120 to obtain the desired media content 102 from storage on the CDN. The video core 101 has already segmented and stored a file information, manifest file and frames of the media content 102 in storage 123 as shown in FIGS. 2 and 3. The content manager 122 will stream the media content 101 as sequential files to the user's device 140 for recording on the DVR 143 in storage 147 and/or to the nDVR recording manager 121 and storage 123 of the resource manager. Problems occur in playback of the media content 102 when one or more uniform frame(s) 102a and non-uniform frame(s) 102b are in the stored stream of media content 102 as illustrated in FIG. 3.

In Step 203, frames or file information containing the media content data is stored in storage 147 on the device 140 or in network storage 123 of the resource manager 120. The stored stream of media content 102 includes all frames including one or more uniform media content data 102a, non-uniform media content data 102b of the files and/or frames of transmitted and stored media content 102.

In Step 205, the resource manager 120 determines from file information, the manifest file, and catalog 170 instances of non-uniform media content data 102b in the recorded stored media content 102 as is described herein.

In Step 207, the resource manager 120 identifies from file information, the manifest file, and catalog 170 where uniform media content data 102a is stored in the system e.g. network storage 123 on the resource manager 120, video core 101, video edge 110, or in other system storage locations.

In Step 209, the resource manager 120 obtains the uniform media content data 102a stored in the system e.g. network storage 123 on the resource manager 120, video core 101, video edge 110, or in other system storage locations.

In Step 211, the resource manager 120 stores the uniform media content data 102a for the non-uniform media content data 102b recorded for the content media 102 in the nDVR 122 network storage 123 on the resource manager 120 or on the device 140 storage 147. The replacement of the uniform media content data 102a for the non-uniform media content data 102b recorded for the content media 102 may be to correct a dropped frame, no recorded frame, a corrupted frame, a frame of a lower resolution (e.g. SD/HD), and other replacements to provide an optimum playback for the user's experience.

As shown in FIG. 2, the system 100 may be configured with the resource manager 120 as an API designed as a component that resides on the gateway 155. The resource manager 120 is utilized for DVR recording and playback for the user experience 150 on the device 140. The resource manager 120 may be configured to determine pulling ABR segment configurations based on the bandwidth for the DVR 141 function according to the user device 140. For example, when the user tunes to a particular linear channel (or flipping through channels), the UX platform 150 requests a single linear stream from the resource manager 120. If the user navigates away from viewing linear TV the resource manager 120 will release the stream from the device 140. Once the user starts viewing a channel, the UX platform 150 may be configured to report profile changes (such as registering 4K display device in the profile) to the resource manager 140 for further video control 122 of the available bandwidth and ABR resource management.

Referring to FIG.1, according to another embodiment, the system 100 may be configured with the UX platform 150 as an API that connects and subscribes to the resource manager 120 to receive resource notifications. If the UX platform 150 is configured with a mosaic viewing experience for the user having multiple streams displayed at once, In such a system, a main view and multiple other views can display multiple streams in a “mosaic” of tiles. The UX platform 150 may manage bandwidth of all the tiles on the Mosaic view, e.g. bandwidth for all mosaic tiles may utilize similar same bandwidth as a normal stream. When a user requests to view a video in full screen from a Mosaic view tile, UX kills the Mosaic view stream and requests a new stream for the full screen video. If a user goes back to the Mosaic view from playing a video (or an ongoing DVR recording is displayed in the Mosaic view), the video still consumes one stream until it gets stopped by the user. For any playback that requires an additional stream, the UX platform communicates with the resource manager 120 to request the stream.

In operation, the resource manager 120 can be configured to determine whether a stream may be allocated based the resources, policies, and applicable number of rules such as by the content management 122 and token restriction check 144. The resource manager 120 then broadcasts the list of streams with their latest statuses to all connected devices 140 to UX platform 150 of clients and to the DVR 143 function. The UX platform 150 may present the information to the device 140 of a user as needed to resolve resource conflicts such as, for example, the user may choose to end some conflicting streams to manually resolve the conflict. For any user actions that cause bandwidth resource changes, which include a stream starts and a stream stops, the UX platform 150 must report such events to the resource manager 120. The resource manager 120 will update the resource statuses accordingly. The UX platform 150 is configured to have the user's DVR 143 report to the resource manager 120 with current statuses of its streams.

The resource manager 120 broadcasts the list of streams including active streams and terminated/stopped/blocked streams to all connected UX platform 150 clients. The UX platform 150 must process such notifications and take actions when necessary. DVR 143 connects and subscribes to the resource manager 120 to receive resource notifications. Near recording start time, whether it is X minutes (X is configurable by the DVR 143) or immediately before a recording starts (for impulse recordings), the DVR 143 must communicate with the resource manager 120 to request resource for a recording to start.

The resource manager 120 determines whether a stream can be allocated based on a number of rules. The resource manager 120 then broadcasts the list of active streams and terminated streams to all connected UX platform 150 clients and the DVR 143. The UX platform 150 may present the information to the user as needed. In case of resource conflict, the user may choose to end some conflicting streams to manually resolve the conflict. If a recording cannot be started due to conflict constraints, the DVR 143 reports the blocked (or failed) status back to the Scheduler Service 160. For any events that cause resource changes, which include a recording starts/stops/fails, the DVR 143 must report such events to the resource manager 120. The resource manager 120 will update the resource statuses accordingly. The resource manager 120 broadcasts the list of streams including active streams and terminated/stopped/blocked streams to all connected UX platform 150 clients and DVR 143. The DVR 143 must process such notifications and take actions when necessary.

Accordingly, the personal channel system and method 100 can be configured to create personal channels for multiple subscribers the resource manager 120 and aspects of the CDN and system. A personalized channel may be a combination of an existing linear channel, media content in storage 147 (e.g. on the hard drive) of the user's device 140 for recording on the DVR 143, stored media content on storage 123 (e.g. in the operator facility) on the nDVR recording manager 121 of the resource manager, and/or media content delivered directly from the media content provider and/or programmer. The method of the present invention can be configured to store a predetermined arrangement of programming of the media content data in any storage 123, 127 so as to form a personalized channel for a particular user or subscriber of services in the CDN. Storing media content data from program to program can be utilized to form said predetermined arrangement of programming for the user's personalized channel such that the personalized channel is configured unique to the particular user's viewing preferences. The personal channel system and method 100 has additional advantages in storing media content data for individual programs obtained from any source in the CDN such as, for example, catalog one or more file information corresponding to media content data available in video-on-demand (VOD), digital video recording (DVR), network digital video recording NDVR or other file information corresponding to media content data sources from said CDN. The personal channel system and method 100 of the present invention has increased flexibility and adaptability to form a personalized channel configured unique to the particular user's viewing preferences and to enhanced the user experience.

While certain configurations of structures have been illustrated for the purposes of presenting the basic structures of the present invention, one of ordinary skill in the art will appreciate that other variations are possible which would still fall within the scope of the appended claims. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1-10. (canceled)

11. A content delivery network configured to provide a subscriber personal channel, comprising:
at least one computer that executes software to:
gather characteristics for a subscriber from service requests received from a device within a predetermined period of time that correspond to selections for linear and non-linear content from a guide;
obtain metadata file information from the characteristics;
identify content for a linear personal channel for the subscriber based on the metadata file information, the identified content including broadcast content and on demand content; and
deliver the identified content as the linear personal channel for the subscriber via an access link between the device and a source of the identified content.

12. The content delivery network of claim 11, wherein the computer determines a schedule at which times the broadcast content and the on demand content of the identified content are delivered via the access link.

13. The content delivery network of claim 12, wherein the computer assembles guide data for the linear personal channel using the determined schedule.

14. The content delivery network of claim 13, wherein the computer transmits the guide data for the linear personal channel to the device.

15. The content delivery network of claim 11, wherein the computer obtains the identified content from the source of the identified content.

16. The content delivery network of claim 15, wherein the computer transmits the obtained identified content to the device.

17. The content delivery network of claim 15, wherein device stores the delivered identified content.

18. A method for providing a personal subscriber channel, comprising:
gathering characteristics for a subscriber, using a content delivery network, from service requests received from a device within a predetermined period of time that correspond to selections for linear and non-linear content from a guide;
identifying content for a personal channel for the subscriber, using the content delivery network, based on the characteristics, the identified content including broadcast content and on demand content; and
linearly delivering the identified content as the personal channel for the subscriber to the device using the content delivery network.

19. The method of claim 18, wherein the linearly delivering the identified content as the personal channel for the subscriber to the device comprises streaming the identified content to the device.

20. The method of claim 18, wherein the identifying content for the personal channel for the subscriber comprises determining at least one location for the content.

21. The method of claim 18, wherein the linearly delivering the identified content as the personal channel for the subscriber to the device comprises pulling adaptive bitrate segments of the identified content.

22. The method of claim 11, wherein the pulling adaptive bitrate segments is dependent on a bandwidth for the device.

23. The method of claim 18, wherein the linearly delivering the identified content as the personal channel for the subscriber to the device comprises:
determining a portion of the identified content is unavailable; and
replacing the unavailable portion of the identified content.

24. The method of claim 18, further comprising allocating a single linear stream to the device wherein the wherein the linearly delivering the identified content as the personal channel for the subscriber to the device comprises delivering the identified content via the single linear stream.

25. The method of claim 24, further comprising:
determining the subscriber navigated away from the personal channel; and
releasing the single linear stream.

26. A resource manager device that provides a subscriber personal channel, comprising:
at least one processing unit;
instructions, stored in at least one non-transitory storage medium, executable by the at least one processing unit to:
gather metadata file information from service requests received from a device that correspond to a selections by a subscriber for linear and non-linear content from a list;
determine content for a personal channel based on the metadata file information, the determined content including broadcast content and on demand content; and
transmit the determined content as the personal channel for the subscriber to the device in a linear sequence.

27. The resource manager device of claim 26, wherein the instructions are further executable by the processing unit to store the metadata file information.

28. The resource manager device of claim 26, wherein the personal channel includes airing times for the broadcast content and the on demand content.

29. The resource manager device of claim 26, wherein the linear sequence comprises a predetermined arrangement of the broadcast content and the on demand content

30. The resource manager device of claim 26, wherein the device comprises a set-top box.

31. The resource manager device of claim 26, wherein the device comprises a digital video recorder.
